(19) United States
(12) Patent Application Publication
(10) Pub. No.: US 2009/0164701 A1
(43) Pub. Date: Jun. 25, 2009

(54) PORTABLE IMAGE INDEXING DEVICE

(76) Inventors: Thomas J. Murray, Cohocton, NY (US); Michael Andrew Swatko, Wilton, NH (US)

Correspondence Address: Frank Pincelli;Patent Legal Staff, Eastman Kodak Company, 343 State Street, Rochester, NY, 14650-2201, US

(21) Appl. No.: 11/960,810

(22) Filed: Dec. 20, 2007

(51) Int. Cl. G06F 12/02

(52) U.S. Cl. 711/103; 711/E12.008

(57) ABSTRACT

A portable image-indexing device that includes a port adapter for connecting to a personal computer and a port adapter for receiving a camera card. The device includes memory for storing a plurality of image and video files and for storing image indexing application programs. A processor performs image indexing on images and/or videos and includes a power source.

### FIELD OF THE INVENTION

The present invention relates generally to image indexing devices, in particular, to a portable image-indexing device.

### BACKGROUND OF THE INVENTION

In the past decade, the photographic industry has seen an unprecedented growth in the number of digital photographic exposures. Millions of photos are saved by photographers on various types of digital storage devices each day. For the year 2006, it has been estimated that over 150 billion digital camera and camera phone images were saved on digital storage devices in the U.S. According to leading experts in the field of photography, this number will jump to over 500 billion in the year 2011. Digital camera owners in the U.S. currently, on average, each have stored on digital storage devices more than one thousand images, and the number is growing each day. Finding a specific photo out of all these stored images is a daunting task for users if their images are not indexed or tagged properly.

Tagging images has been a technique used since the introduction of the digital camera. The date and time of exposure, camera settings, and flash/focus responses, for example, are all considered tags that are automatically stored with an image by the camera. In addition, users are able to manually access individual images on a PC and tag each image in their image collections by renaming the image files with more descriptive labels than the automatically generated camera filename. For example, a user may want an image file to be called “Sally's birthday” versus a camera-generated name of 100_{—}3642.jpg. Users can also add titles, captions, keywords, and location names to an image file. The specifications for image files that contain tags is well known in the art, and will not be described in detail herein.

More advanced tagging has been introduced to enhance the user experience of sorting through stored image collections and to aid downstream searching and organization of picture collections. These more advanced tagging techniques are known as “indexing”. The term is used herein to describe any image analysis method that analyzes the images to automatically generate tags that are then associated with a particular stored image. Indexing algorithms typically attempt to determine the content of an image and then generate appropriate indexing metadata to be stored in association with the image. This index information could include: image quality attributes (e.g., an image value indexing algorithm), interest points, people recognition, object detection and recognition, key frame detection and/or extraction from stored videos, etc.

Face detection is an indexing algorithm that helps users sort their image collections based on “people pictures” versus “non-people pictures”. A people recognition indexer algorithm will aid organization of an image collection by finding faces, obtaining a map of the facial feature points for each face, and comparing face maps and grouping the face maps that are most likely the same person. A people recognition algorithm then tags images with the name of person(s) contained within an image. This algorithm typically requires a user to “train” the people recognition algorithm by manually typing in the names of the people that are detected within a scene. The people recognizer will then associate the “named” faces with those that it finds in the remainder of the collection and will automatically tag them. The people recognition algorithm is computationally intensive and is not typically found in cameras due to the normally lower CPU processing capability found in most cameras. Thus, the people recognition indexer normally needs to be run “off-line” from the camera device, for example, on a PC or other processing system. It should be understood that many other tagging and indexing applications and algorithms are possible, and those skilled in the art will be able to associate other metadata generating programs, and image processing techniques and methods with “indexers”.

The typical workflow for digital photographers is to transfer pictures captured on a digital camera to a Personal Computer (PC) either via a docking system, cables, or removing the camera card from the camera and inserting it into an accessory device connected to their PC.

Many new “indexers” are becoming available in the marketplace for use with digital cameras, for example, face detection, image quality fixes, key frame extraction from videos, auto-cropping, and facial retouching, to name just a few. Newer and highly featured imaging algorithms require a tremendous amount of computational power that exceeds the capabilities of most portable image capture devices. Algorithms such as people recognition, object detection, image value and event detection fall into this category. Most cameras currently do not support these features. Since most computationally intensive image processing algorithms do not run on portable capture devices, a user will most likely use their PC or an online web server to index their images. This requires the user to upload their images to the PC or online service before the image indexing can occur. In this instance, the user must wait for the images to be “indexed” before they can properly interact and organize their photo collection assets, this delay might cause frustration and reduce their enjoyment of the experience.

Another workflow option for a user is to take a camera card that contains a number of images directly to a photo kiosk. A well recognized requirement for photo kiosks is to reduce user's waiting time to a minimum. So the images must be loaded, processed and printed very quickly. The kiosk device owner would like to have the latest image processing algorithms to enhance features for users and provide them with more output options. Some kiosk users process their images on PCs prior to taking them to a kiosk. They copy their image files from their PC to camera cards or other portable media (CD or DVD) and take them to the Kiosk. The user's time is spent indexing the images at the PC, copying the images to a transportable media, and then traveling to the kiosk. This is a type of workflow that can be improved. Such a workflow requires both the possession of a computer and a relatively high level of computer savvy.

### Computer Indexing:

Typically, camera users transfer their images from a camera card to a PC and then, at some later point in time, the image files are indexed. The image files could be indexed immediately as they are being transferred but this would delay the user from utilizing the camera card to take more pictures. Such a delay is likely to be as much as 10 times longer than the typical delay of transferring image files to the PC because, in addition to the time it takes to transfer image files, additional time is required to index the images. It is possible that, after the image files have transferred, the indexing could be “scheduled” for a later time. At the scheduled time a PC would initiate the indexing process automatically. This is adequate assuming that users will leave their PCs turned on and that the delay required to access their PC is acceptable. The indexed images would be ready for user interaction at some time after the image transfer, but would not be immediately available. Thus, this workflow requires that the PC be readily available and that transporting images from a picture-taking event to the PC is not an obstacle.

### Camera Indexing:

Image indexing via a camera interface likely would interfere with a photographing experience. Indexing via a camera interface could be accomplished by scheduling the indexing when the camera is “idle”. This requires that the camera is energized and processing the image files until the camera is required for use again. This approach has some deficiencies in that the camera must have enough battery power to continuously operate or be connected to some power source to charge the battery and to continue the indexing operation. When a user is traveling and intermittently utilizing the camera it might interrupt the indexing process.

### Laptop Indexing:

Laptop computers have sufficient processing power to index images but their large form factor interferes with portability. Laptops are not typically turned on while they are being transported. A user typically will place a laptop in a Standby mode to save battery power before transporting the laptop. Indexing can easily take hours to complete, based on the number of images and videos, and the resolution of the image files.

### PDA Indexing:

A Personal Digital Assistant is an electronic device, which can include some of the functionality of a computer, a cellphone, a music player, or a camera. This device is portable and accessible, however, PDA's also run other applications simultaneously, either the indexing step would slow the other applications inordinately or it will not provide enough bandwidth to index images in a reasonable amount of time.

### SUMMARY OF THE INVENTION

In one preferred embodiment, the present invention is implemented in a portable dedicated Image Indexing Device (IID) that indexes images captured by a digital camera and is capable of connecting to a computer, a picture frame, a printer, etc. Such a device can be implemented as a thumb drive apparatus comprising a slot for receiving a camera card, such as a flash card, having images stored thereon. Typical types of flash cards include CompactFlash™, xD Picture Card™, SD™, SmartMedia™, Memory Stick™, MultiMediaCard™, or SmartMedia™, etc. Internal memory or storage is coupled to the slot for electronically transferring images from the camera card to storage. The stored program then automatically indexes the images and stores the indexing data such that it is associated with the corresponding images. A connector, such as USB, couples the device to a USB receptor, such as on a PC, for transferring the indexed images to the coupled device. Thus, after transferring indexed images from the device to a PC, an image editing application installed on the PC can be used to manipulate indexed images.

Other embodiments that are contemplated by the present invention include computer readable media and program storage devices tangibly embodying or carrying a program of instructions readable by machine or a processor, for having the machine or computer processor execute instructions or data structures stored thereon. Such computer readable media can be any available media, which can be accessed by a general purpose or special purpose computer. Such computer-readable media can comprise physical computer-readable media such as RAM, ROM, EEPROM, CD-ROM, DVD, or other optical disk storage, magnetic disk storage or other magnetic storage devices, for example. Any other media, which can be used to carry or store software programs which can be accessed by a general purpose or special purpose computer are considered within the scope of the present invention.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications. The FIGS. below are not intended to be drawn to any precise scale with respect to size, angular relationship, or relative position.

### BRIEF DESCRIPTION OF THE DRAWINGS

FIGS. 1 and 2 illustrate timing diagrams of camera and PC utilization as a function of time;

FIG. 3 shows one exemplary embodiment of an indexing device with a block diagram of an example system configuration;

FIG. 4 is an exemplary flowchart of an image indexing devices image processing workflow; and

FIG. 5 is an exemplary flowchart of an image indexing devices PC interface workflow.

### DETAILED DESCRIPTION

According to one embodiment of the present invention, an IID has been designed to be a simple and effective solution for indexing images from digital camera image files independently from the camera and independently from a PC or kiosk. The IID is simple enough to be used by novice users, and yet sophisticated enough to perform the latest intensive computer processing imaging algorithms and indexers. The device is a small-sized, battery-powered (40 hours between charging), inexpensive hardware solution for digital camera image indexing. The device is meant to process the images off-line from a PC and off-line from a digital camera. The images can be copied or offloaded to the device, utilizing the camera card interface and based on a user-selected option, into internal storage of the indexing device. The camera card can then be returned to the camera for continued use or for reuse. The indexing is performed by the device automatically after the user transfers images to the device. The camera remains free for further image storage and the user will not be burdened with image processing while waiting for a PC or kiosk. Image indexing continues while the user operates the camera or while performing another activity unrelated to photography. Typical indexing may take as long as 1 minute per image depending on the number and type of indexing algorithms that the device incorporates. The workflow for the user is efficient since the indexing is likely to be completed before the user interacts with their images on a PC or kiosk, therefore, a user is able to interact with their indexed images immediately after transferring them to their PC.

After the images have been indexed within the IID the user is likely to want to do something with their pictures. At a kiosk they simply place the IID device into the kiosk using the USB interface and the indexed images are copied into the kiosk memory. Since indexing is complete the kiosk does not have to perform indexing operations such as face detection, event segmentation, or key frame extraction, etc. This reduces the time the user must wait before they interact with their pictures.

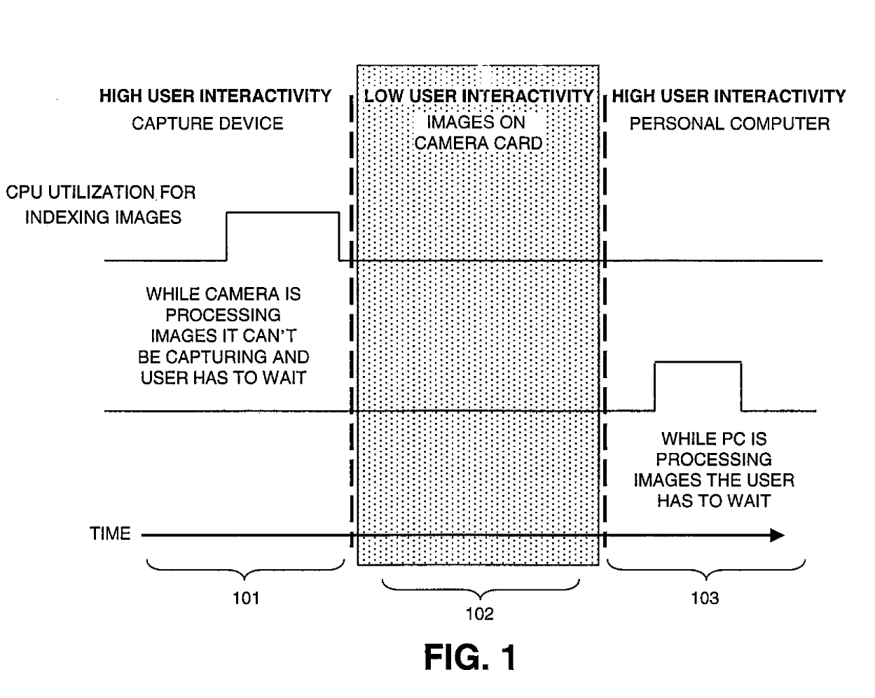

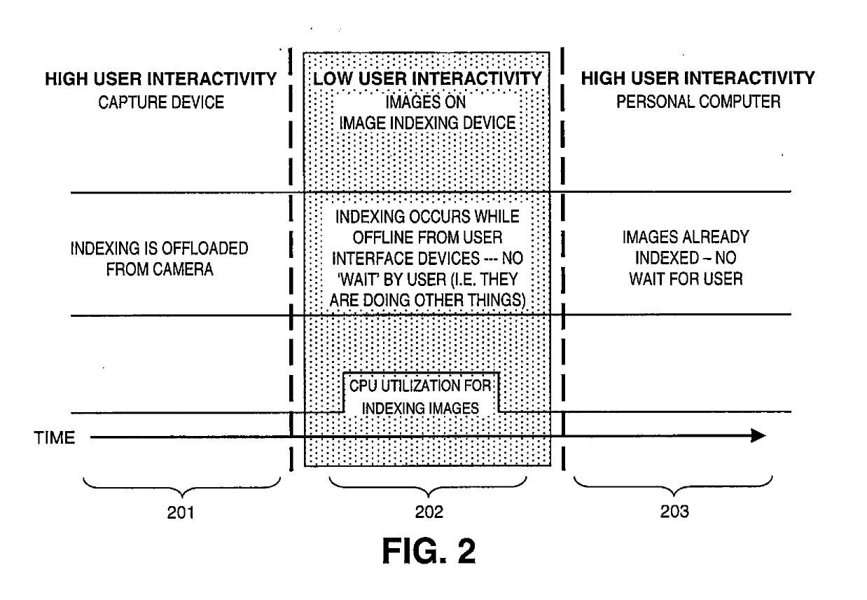

With reference to FIG. 1, there is depicted a typical workflow for a digital camera user sectioned into three broad, generalized time windows. In general, there is a first time period 101 consumed by a user for capturing images, then there is a second time period 102 after capturing images but before a third time period 103 of accessing the images on a PC using an image editing or an image viewing application. The first time window 101 and the third time window 103 illustrate time periods requiring high user interactivity with image handling devices. The first time window 101 illustrates user interaction with a camera, or other image-capturing device, which demands a user's attention while capturing images. This time window leaves little time for a user to index the captured images because a user's attention is required to operate the camera. The third time window 103 depicts a typical user's interaction with an image editing application installed on a PC, after having captured the images. If the PC is used to index the captured images, manually or via installed indexing programs, the user has to wait. The present invention takes advantage of the second time window 102 to index images. As illustrated in FIG. 2, the time period 202, after the time period 201 during image capture and prior to the time period 203 when a user is accessing a PC for editing the captured images, is an ideal time for indexing the images. The IID device of the present invention can utilize this second time period to index images while the user is occupied with other activities.

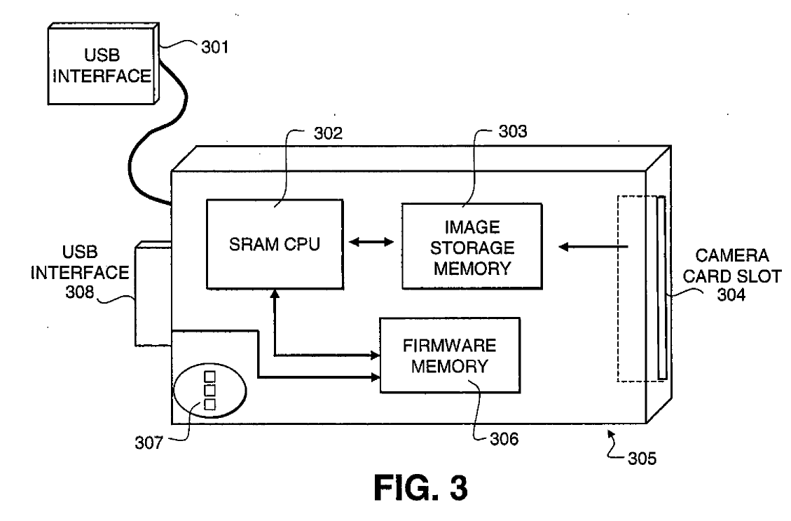

With reference to FIG. 3, the IID 305 includes a camera card slot 304, which will receive the camera card. The camera card slot includes electrically conductive contacts (not shown) for electrically communicating with electrical contacts on the camera card. Multiple types of camera cards can be inserted into the slot and coupled to the IID, including CompactFlash™, xD Picture Card™, SD™, SmartMedia™, Memory Stick™, MultiMediaCard™, or SmartMedia™, etc. An image storage memory 303 receives and stores the image files transferred from the camera card. This storage memory is large enough to receive and store the contents of a camera card. The storage memory can be one of several types such as Flash memory, or battery-powered static RAM (SRAM). CPU 302 controls operations of the IID and controls processing of the image indexing algorithms. A firmware memory 306 contains the image analysis program. The firmware memory can be one of several types such as Flash memory or EEPROM. USB interface 308 connects to other devices with USB portal connectors such as a PC for transferring images from the IID. An illuminated indicator 307 is used to signify when the IID is copying, indexing images, or idle. Also, an optional USB cable interface 301 provides an alternative means to connect to devices with a USB portal connector, such as a PC. An optional wireless capability could be used to provide connectivity to other wireless enabled devices such as a PC or kiosk, etc. The IID is powered by an internal power source (not shown) such as a battery.

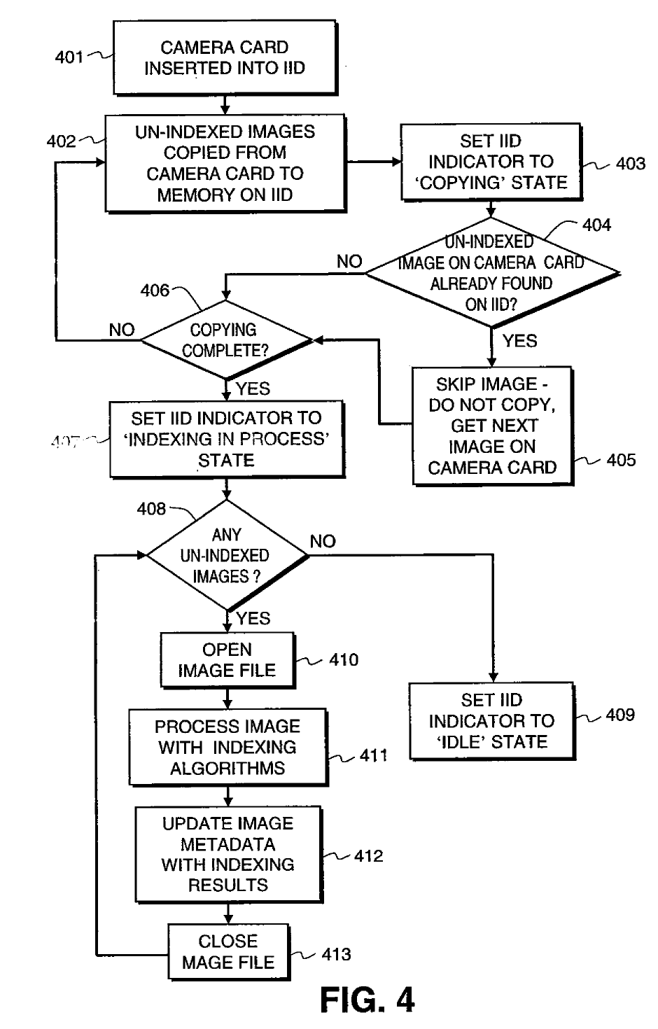

FIG. 4 illustrates a flow chart showing operation of an embodiment of an IID. The operation of the IID begins with step 401 when the user inserts a camera card into the camera card slot on the IID. This action causes the IID to automatically initiate an “image copying” operation. If images stored on the camera card have not been indexed they will be copied to the storage memory 402. Images that have been indexed will have a metadata tag set to “Indexed_v1” within the metadata portion of the image file. The copying operation opens the image file and interrogates the metadata tag and determines if the Indexed_v1 is set. If the metadata tag is set, the IID will not copy that image to its storage memory because the image has already been indexed. The illuminated indicator is set to the “copying” state at step 403 so that the user can easily see that the indicator is signifying that the copying operation is proceeding. During the “copying” state, the illuminated indicator can optionally be programmed to flash on and off at a periodic rate (e.g., “on” for 500 ms and “off” for 500 ms), for example, or one of several indicators, such as an LED, can be illuminated during the copying state.

Next, at step 404 the file name of the first image on the camera card is compared to the file names of all the images already on the IID (if any). If the image file name matches any files on the IID there must have been a copy left over from a previous session so the IID skips that image in step 405 and does not copy that particular image. This step of comparing file names saves indexing time and image storage memory. The copying process above continues for the next image, checking to see if the image file is already on the IID and performs the copying operation if there is no other image file with the same name in the image storage memory. This process continues until all the un-indexed, and not previously copied image files on the camera card have been copied to the IID. Once the last image file has been successfully copied to the IID in step 406 the illuminating indicator switches to the “indexing in process” state at step 407. The illuminating indicator can be programmed to a different flashing sequence from the copying state (e.g. “on” for 100 ms and “off” for 2 seconds) or to illuminate a different light source, such as a second LED, to indicate to the user that copying is complete and indexing has begun. After indexing has begun, the user can safely remove the camera card from the IID. The images on the camera card have not been touched or modified in any way. The user can place the camera card back into the camera (or any device that accepts a camera card) and delete or manipulate the images thereon in any manner desired.

The indexing process begins as soon as the IID detects an un-indexed image in the image storage memory at step 408. Thus, indexing can occur simultaneously with the copying operation. The IID opens the un-indexed image file at step 410 and performs a series of image analysis algorithms such as face detection, interest point detection, object detection, key frame detection from videos, etc., at step 411. The IID will update the image file metadata at step 412 based on the results of the image analysis algorithms. This may be in the form of metadata tags that simply indicate the number of faces found within the image scene, where the faces are located within the scene (x,y coordinates) and the size of the faces found. Once all the selected image analysis algorithms have been performed and the image file metadata is updated for a particular image file, the image file is then closed at step 413 and the IID checks for more un-indexed images at step 408 and the program continues to step 410 if there are more un-indexed images in the IID memory. When all the image files have been processed and there are no more un-indexed images, the IID goes into an “idle” state at step 409 which sets the illuminating indicator into an “idle” state flashing mode (e.g., “on” for 100 ms and “off” for one minute), or by illuminating another light source, such as a third LED, to indicate to the user that the IID is in an idle state.

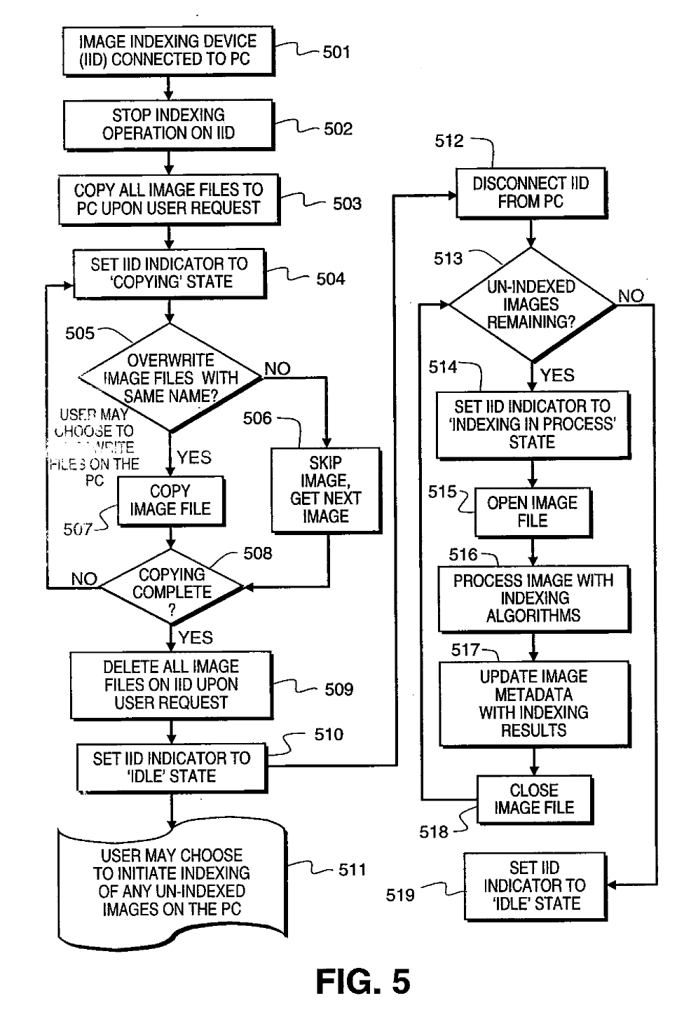

With reference to FIG. 5, there is depicted another preferred embodiment of the present invention connected to a PC. In this embodiment, a user connects the IID to a PC's USB portal via the USB connector on the IID (using either the connector 308 or tethered USB 301 shown in FIG. 3) or via a wireless connection. As soon as the IID is connected to the PC at step 501 the IID is energized through the USB connection. The USB connection will provide recharging power to the battery (not shown) as long as the IID is connected to the PC and the PC is powered on. The IID also changes state when first connected to the PC if the IID is in the “indexing” state and is currently still indexing images. In that case it will stop indexing, at step 502, and immediately switch to the “copying” state at step 503. In the copying state all the image files will be copied from the IID to the PC, whether or not they have been indexed on the IID, following the same process as any standard thumb-drive device that is connected to a PC. For example, the operating system of the PC will determine how to handle the new device that is found in the USB portal. Typically, the OS will provide a pop-up menu that informs the user of several options. One option is to copy the image files to a location on the PC. This is performed if the user selects this option at step 503. At step 504 the IID indicator illuminates, as described above, to indicate that the device is currently in the “copying” state. During the copying step 503 the target device OS may encounter images on the target device (e.g., PC, Kiosk, etc.) with the same name. At this point the user is presented with a pop-up alert message to provide the user an opportunity to indicate their preferred operation. If the user chooses at step 505 to overwrite the existing image file then the image from the IID is copied to the target device at step 507, which overwrites the existing image file. This may be preferred when the user knows that the images on the target device have not been indexed and they would like to update the image file with the indexing metadata. At step 505 the user may choose to only copy unique image files and not to overwrite existing image files. In this case the copying operation skips over the IID image file at step 506 and continues the copying operation. When copying is complete as determined at step 508 the illuminated indicator changes to indicate the “idle” state at step 510, as described above. If the user removes the IID from the PC at this point, at step 512, the images will have already been indexed and the user does not have to wait for image processing or indexing. The user is free to start interacting with the photo applications on the PC using the indexed images.

Additionally, at step 509 the user may select to delete the images from the IID after the copying operation. Deleting the images from the IID is the preferred method, however, the user may choose not to do so. For instance, if the IID was connected to the PC before the IID indexing was completed, as described above with respect to step 502, there still may be some un-indexed images on the IID and the user may want the device to complete the indexing task. Optionally, at step 511, the user may manually index the images on the PC or activate an indexing algorithm that is installed on the PC. After the copying operation has completed, the illuminating indicator will change from a “copying” state to either an “idle” or “indexing” state. If the IID determines, at step 513, that there are no un-indexed images remaining on the IID, the illuminated indicator will change to the “idle” state at step 519. If the copying process is completed and there are un-indexed images remaining on the IID, as determined at step 513, the IID indicator will change to the “indexing” state at step 514, and the IID will continue indexing the un-indexed images. At step 515 the IID opens the next un-indexed image file at step and performs a series of image analysis algorithms such as face detection, interest point detection, object detection, key frame detection from videos, etc., at step 516. The IID will update the image file metadata at step 517 based on the results of the image analysis algorithms. This may be in the form of metadata tags that simply indicate the number of faces found within the image scene, where the faces are located within the scene (x,y coordinates) and the size of the faces found. Once all the selected image analysis algorithms have been performed and the image file metadata is updated for a particular image file, the image file is then closed at step 518 and the IID checks for more un-indexed images at step 513. Indexing will be completed when all the un-indexed images have been indexed. As before, the metadata for each indexed image will be updated with the appropriate metadata tags, at step 517. When indexing completes the state of the IID will be set to “idle” at step 519.

### ALTERNATIVE EMBODIMENTS

It will be understood that, although specific embodiments of the invention have been described herein for purposes of illustration and explained in detail with particular reference to certain preferred embodiments thereof, numerous modifications and all sorts of variations may be made and can be effected within the spirit of the invention and without departing from the scope of the invention. Accordingly, the scope of protection of this invention is limited only by the following claims and their equivalents.

What is claimed is:

1. Apparatus comprising:
a thumb drive comprising:
a slot for receiving a camera card having images stored thereon;
storage electrically coupled to the slot for transferring the images from the card to the storage;
programmed means for automatically indexing the images, the automatic indexing intended for later utilization by an image editing application installed on a computer; and
a connector for electrically connecting the thumb drive to the computer and for transferring the indexed images to the computer.

2. The apparatus of claim 1 wherein the computer is selected from a PC, a kiosk, a hand held computer, or a laptop.

3. The apparatus of claim 1, wherein a format of the camera card is selected from CompactFlash, xD Picture Card, SD, SmartMedia, Memory Stick, MultiMediaCard, or SmartMedia.

4. The apparatus of claim 1, wherein the storage comprises a memory type selected from flash memory or SRAM.

5. The apparatus of claim 1, wherein the programmed means comprises a program stored in a memory type selected from flash memory or EEPROM.

6. The apparatus of claim 1, further comprising an indicator for indicating that images are currently being transferred from the card to the storage or that the images are currently being transferred from the storage to the computer.

7. The apparatus of claim 1, further comprising an indicator for indicating that images are currently being indexed by the programmed means for automatically indexing the images.

8. The apparatus of claim 1, further comprising an indicator for indicating that the apparatus is in an idle state.

9. Method comprising:
providing a thumb drive having an indexing algorithm stored therein and storage for storing images;
coupling the thumb drive to a camera card having images stored thereon;
automatically transferring the images from the camera card to the storage; and
automatically activating the image indexing algorithm for indexing the images in the storage.

10. The method according to claim 9, further comprising the steps of:
the indexing algorithm generating metadata for an image in the storage;
associating the metadata with the image in the storage; and
storing the metadata in the storage.

11. The method according to claim 9, further comprising the step of:
illuminating an indicator on the thumb drive during the step of automatically transferring the images.

12. The method according to claim 9, further comprising the step of illuminating an indicator on the thumb drive during the step of automatically activating the image indexing algorithm.

13. The method according to claim 9, wherein the indexing algorithm utilizes an algorithm selected from a face detection algorithm, an image value-indexing algorithm, a people recognition algorithm, an object detection algorithm, or a key frame extraction algorithm.

14. The method according to claim 9, further comprising the step of:
coupling the thumb drive to a computing device; and
transmitting the image in the storage and the metadata associated with the image to the computing device.

15. The method according to claim 14, wherein the computing device is selected from a PC, a kiosk, a hand held computer, or a laptop.

16. The method according to claim 9, wherein a format of the camera card is selected from CompactFlash, xD Picture Card, SD, SmartMedia, Memory Stick, MultiMediaCard, or SmartMedia.

17. The method according to claim 10, further comprising the steps of:
coupling the thumb drive to a computing device prior to the indexing algorithm having generated metadata for all images in the storage;
terminating the indexing algorithm; and
transmitting all images in the storage and the metadata associated with at least one of the images to the computing device.

18. The method according to claim 17, further comprising the step of automatically reactivating the image indexing algorithm, after the step of transmitting all images, for indexing remaining un-indexed ones of the images in the storage.

19. The method according to claim 9, wherein the storage is selected from flash storage or SRAM.

20. The method according to claim 9, wherein the indexing algorithm is stored in a flash memory or in EEPROM.
